(19) United States
(12) Patent Application Publication
(10) Pub. No.: US 2022/0101683 A1
(43) Pub. Date: Mar. 31, 2022

(54) Data Science and Machine Learning Based Fantasy Bingo System

(71) Applicants: Bruce Elliott, Rochester, NY (US); David Silva, Santa Maria, CA (US); David Mckenzie, Rochester, NY (US); Jacob Lindorff, Lidingo (SE)

(72) Inventors: Bruce Elliott, Rochester, NY (US); David Silva, Santa Maria, CA (US); David Mckenzie, Rochester, NY (US); Jacob Lindorff, Lidingo (SE)

(21) Appl. No.: 17/033,851

(22) Filed: Sep. 27, 2020

(51) Int. Cl. G07F 17/32

(52) U.S. Cl. CPC G07F 17/3227; G07F 17/329

(57) ABSTRACT

Fantasy Bingo is a blend of the traditional Bingo game and fantasy sports, whereby the squares of the bingo card are replaced with sports achievements for players to unlock with real-world performance. Embodiments described here within generally relate to systems, methods, and Apparatus for utilizing artificial intelligence and data science to improve probability calculations related to fantasy sports. For example, the NBA 3 pt attempts/game increased from 2.8 to 29 between 1980 to 2018! The AI system can dynamically adjust our probability calculations to best fit with the trends in sports. Fantasy Bingo can also be played over multiple games based on cumulative statistics.

### BACKGROUND

Fantasy sports has seen a dramatic rise and altered how fans watch and interact with sporting events. Fantasy sports is an interactive game where users select actual players to be on their “fantasy” team and can accumulate fantasy points based on the players' real-life performance and a scoring system designed by the fantasy sports operator that allocated points for certain actions.

In the traditional game of Bingo, a user plays the game with a 5×5 square table. The goal of the game is to be able to “cross” a line within the 5×5 table (whether vertically, horizontally or diagonally) and say the word “Bingo” loudly, where each square is crossed when the symbol or number within that square is mentioned by the announcer that tends to pick the numbers blindly from a rotating sphere that contains balls with the numbers or symbols. In the middle of the 5×5 table there can sometimes be a free square, meaning that the game of “bingo” could be over with only four symbols. Whoever has “Bingo” first, wins a prize pool.

### DETAILED DESCRIPTION

The Fantasy Bingo system is a method or process for generating fun and exciting Bingo cards for users to follow along with live sporting events bringing them greater enjoyment and cash prizes. The Fantasy Bingo Card consists of statistical events which have some predetermined probability of occurring during relevant sporting events. The predetermined probabilities are generated by the Fantasy Bingo system. Users build a team of players from real sports teams that will be linked to the Fantasy Bingo Card. There are multiple ways for the user to build teams; import or salary cap. The Fantasy Bingo game can be played over multiple games or a single game depending on the user's selected gameplay.

Fantasy Bingo in one embodiment can consist of a set of 25 or more sporting achievements (e.g., an N×N matrix where N is at least equal to 5) that may come from the official Sports League(s) and where a player or set of players win a Jackpot Prize if they are able to cross a line. Since the Jackpot will be a fixed amount (that is, the house won't be playing the role of a Casino where the losses could be unlimited), the player won't be choosing the events of their table and the payout won't be dependent on the odds of said event(s), but it can merely be equally distributed with all winners, if there's more than one winner.

The challenge for this game of Bingo still requires that probabilities or odds are still calculated for each event that can conform a Bingo table so that when the Bingo Tables are generated for each user, and/or for the whole game, the Bingo probabilities are balanced to reach a certain goal for the system, which could be either to limit the amount of winners on each round of Bingo (because each round will likely be played by a lot more users than one would normally see in a non-virtual game of bingo), or to ensure that all users have the same probability of winning (note that these goals don't always appear together and some of these may not happen at all; the technical decision of how to balance these Bingo Tables can ultimately depend on making this game sustainable, enjoyable and profitable). The techniques used to balance the tables in particular and the game in general will be discussed in the “Data Science and Machine Learning” section of this document.

The Fantasy Bingo system comprises the following major blocks; 1) Fantasy Bingo Card Generator System 1a) Data Science and Machine Learning 2) Verification of Fantasy Bingo Card Results 3) Frontend visualization of the gameplay 4) Team building; Import or Salary cap.

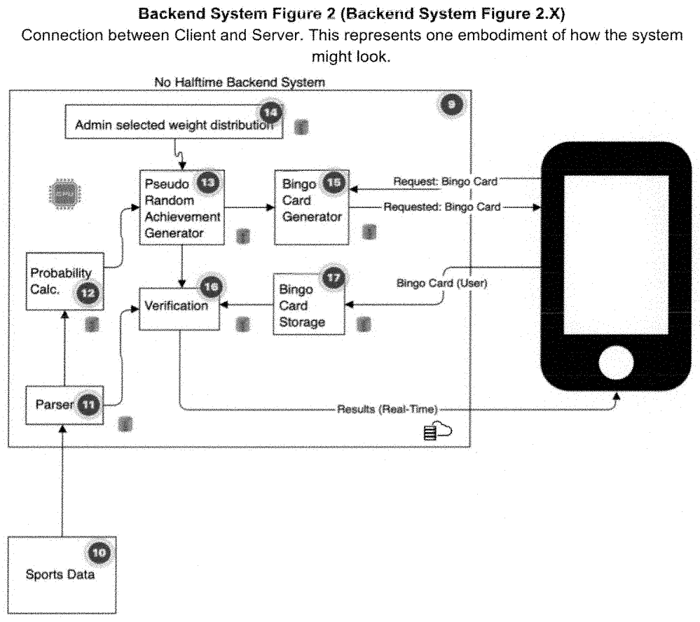

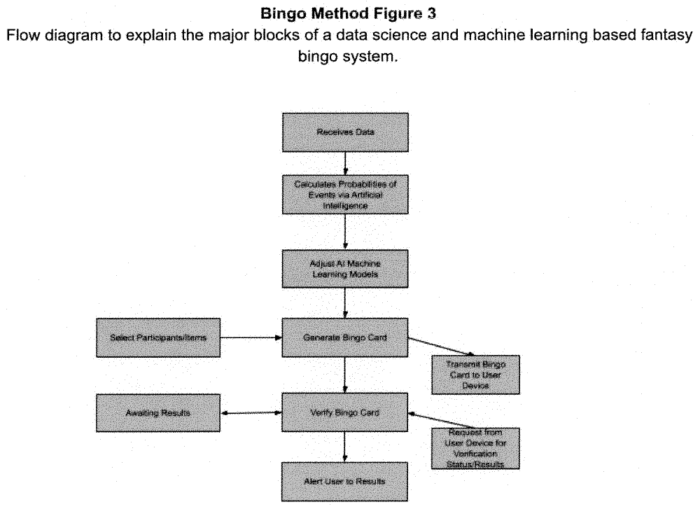

The system which is displayed in FIG. 2 shows an embodiment of the Fantasy Bingo System comprising a processor, database(s)/storage, network communication system, client device, and a real-time notification system.

Fantasy Bingo Card Generator System

The Fantasy Bingo Card Generator System is the core engine of the Fantasy Bingo System (Backend System FIG. 2.11, 2.12, 2.13, 2.14, 2.15). The Fantasy Bingo System receives player data and admin input to generate the Fantasy bingo cards used by the end-user to play Fantasy Bingo. The Fantasy Bingo Card Generator System is responsible for the following functions: 1) Parsing player and team data (Backend System FIG. 2.11) 2) Determination of achievement probability (Backend System FIG. 2.12). 3) Incorporation of Admin created weighting to generate Bingo cards of varying levels of difficulty (Backend System FIG. 2.14) 4) Pseudo random generation of Bingo cards. (Backend System FIG. 2.13, 2.15)

Parsing Player and Team Data

Player data is generated by a 3rd party source and imported into the Parser module. The Parser module receives upcoming match information, player/team data, and real-time match statistics. The 3rd party data provider can retrieve data from any professional or amateur sport/event which records game statistics. The sports/events can consist of the following: football, soccer, basketball, baseball, esports, mixed martial arts, golf, volleyball, swimming, gymnastics, and/or olympics games. The match information contains the following: upcoming games and teams involved, start time, start date, home and away team designation, and game status (in-progress, not started, completed). The upcoming matches allow the system to determine which players of the associated team can participate in the Fantasy Bingo Card generated. The player/team data provides information on which team the player belongs to, example Player X belongs to Team Y. This information is displayed on the player profile. The start time and start date are used by the system to determine when player(s) can no longer be available or eligible to be selected for a Fantasy Bingo Card. For example, players whose game has already started will not be considered for a newly generated Fantasy Bingo card. The start time and start date is also used to schedule jobs/processes such as verification, for example if the system determines a high number of games will be starting at time X, then it will schedule jobs/processes to handle verification more frequently to rapidly process results and alert users of their Fantasy Bingo status (win/lost). Home and away team designation will be used to provide additional details to users when determining which players to use for the Fantasy Bingo card. The player/team match data for completed games is parsed and stored based on teams, players, and player position. This data is the statistics for the overall game(s) and statistics per time period. This data will be fed into the Data Science and Machine Learning portion of the system. The real-time match statistics will be used to validate if a player achievement is unlocked on Fantasy Bingo Cards. The data can be received as XML data with unique ids for teams, players, matches, and statistical categories.

Determination of Achievement Probability

The determination of achievement probabilities is key to the generation of Fantasy Bingo cards as we need to ensure that Fantasy Bingo cards are competitive for users to win. Achievement probability is the likelihood of an event occurring. Every Fantasy Bingo Card can't be filled with easily achieved events or the game would not make sense financially to the business. Bingo cards shouldn't be statistically impossible because users can be discouraged to participate.

So to achieve this competitive outcome in Fantasy Bingo cards, the system must determine the probabilities of events occurring so a determination can be made as to which achievements may be selected for the Bingo Card. In the initial stages of the game historical data may be used to determine the probability of an achievement occurring. Then subsequent probabilities can be determined using data science and machine learning techniques. These probabilities can evolve over time to be inline with the current state of the respective sports. For example, in basketball, 3-point shooting percentages have risen overall for the entire NBA over the last decade which would suggest that 3-point achievements probabilities should be adjusted accordingly.

Predetermination of Achievement Probability

The system will start by importing 3 seasons of data for each sport. The probability of an event occurring is calculated on a per game basis for the season. In one embodiment, the probability is calculated in the following manner:
Determine probability of event occurring on a per game basis for the season→average probabilities across previous seasons.
   Probability calculation (Game)
      [Event occurrences(position)]/[Total Opportunities(position)]
         Players who receive no gametime will not be counted/factored into statistics
         Example:
         Boxscore (Same Player Position): Player A: 1 TD, Player B: 1 TD, Player C: 0 TD, Player D: 0 TD
         50% chance of Players scoring TD
         2/4→½
   Probability calculation (Season)
      Average of probability for season
   Probability calculation (Multiple seasons)
      Average of 3 seasons of probabilities
Group events into 5 buckets based on probability of occurrence:
   Bucket 1: Super high probability of occurrence
      Probability between 80%-99%
   Bucket 2: Reasonable probability of occurrence
      Probability between 60%-79%
   Bucket 3: Average probability of occurrence
      Probability between 40%-59%
   Bucket 4: Below Average probability of occurrence
      Probability between 20%-39%
   Bucket 5: Very low probability of occurrence
      Probability between 1%-19%

Data Sample Granularity

The default range of data to calculate probabilities can be on a multiple season basis to account for a smoother probability distribution. The system's granularity, or window of data, can have the ability to be adjusted by the administrator to account for varying circumstances of a particular sport. The range of data can be able to range from the highest level (multiple seasons) or go all the way down to the lowest levels of data accumulation (real-time, milliseconds). This ability allows the system to account for variations in sports, such as rule changes or non-sporting events which impact gameplay or performance. For example; COVID-19 may force sports teams to evaluate how much physical contact they allow during the game, which may impact the statistical outcomes by leading to more or less scoring. Such a shift would place a higher weight on recent statistics vs. previous season statistics. Given the novelty of COVID-19, it's impact on sports is yet to be known.

Data Science and Machine Learning

To determine the probability of an event happening, statisticians, computer scientists, mathematicians et al have developed several techniques, algorithms and methodologies. These draw from the fields of these experts to different degrees, but they all ultimately aim to measure how likely events are to happen given known information, and to create the most useful models in order to support either strategic or operational decision making. The selected model(s) can be used by the system to perform machine learning of probability calculation.

In the case of Fantasy Bingo, correctly predicting the likelihood of certain sporting events happening given events from the current season and past season is critical. In order to predict how likely that there is going to be a certain score, or score difference, the victory of a particular team or group of teams, or that certain stats can be reached by a team, player or set of players, many techniques may be used. Techniques consisting of, but not limited to, the following: Logistic Regression, eXtreme Gradient Boosting, Deep Neural Networks, Naive Bayesian Models, and Bayesian Networks. The decision of which model can be determined based on which technique gives the best accuracy and which can aid to better improve upon the users' experiences and ultimately the bottomline.

Regardless of which technique is determined, it should satisfy the following requirements:
1. It takes into account all of the relevant Sports League information to predict events within said sports leagues
2. Can make all predictions relevant to fantasy sports
3. Can update its probability predictions when new events happen
4. Can be queried for probabilities of the aforementioned events in order to build the Fantasy Bingo tables

Admin Weights

All achievements can be given an Admin determined weighting. The achievements may have their calculated probabilities but a factor is required to determine how likely the achievement can be selected for the Fantasy Bingo Card. The weighted distribution value may range between 0%-100%. In the scenario where an achievement has a weighted probability of 90%, the achievement can have a high probability of being selected for a Fantasy Bingo Card. The Admin weights may be set in the backend.

Pseudo Random Bingo Card Generation

The Fantasy Bingo Card is generated with a pseudo random algorithm which ensures competitiveness of the game, neither the admin nor users have a dramatic advantage over the other. The generation of the Fantasy Bingo Card can have the following steps:
Create weighted pseudo-random function to generate
   Most frameworks and languages have built-in random number generators which can be adapted to create a weighted pseudo random function. The random number generator function is commonly written as RAND( ). Below is a simplified algorithm for demonstration purposes:
      Simplified Algorithm
         Goal is to generate 3 numbers with certain numbers occurring more than others based on weighted value
         1:60%, 2:30%,3:10%
         Generate a matrix of 10 values with 60% of values being 1, 30% of values being 2, and 10% of values being 3
         [1,1,1,1,1,1,2,2,2,3]
         Randomly rearrange matrix of values
         [1,2,2,1,1,1,1,1,3,2]
         Use random generator function 3× to select values/index from matrix (for loop)
         rand(10)=2→2nd position in matrix [1,2,1,1,1,1,1,3,2]
         rand(10)=5→5th position in matrix [1,2,2,1,1,1,1,1,3,2]
         rand(10)=6→6th position in matrix [1,2,2,1,1,1,1,1,3,2]
         Output is 2,1,1
         This algorithm can naturally be expanded for generation of 25 achievements to fill out the Fantasy Bingo Card
Use weighted pseudo-random function generator to select bucket and then randomly choose event/achievement from bucket to place on player card
   events/achievements can not be duplicated on player card
Generate full bingo card with human form text in squares of player card
   Variation 1
      Center square is a sports achievement
   Variation 2
      Center square is a free square
   Variation 3
      Center square is automatically unlocked if the user correct answers sports trivia
   Variation 4
      Center square is used for the player to guess how many fantasy points their lineup will score in a given time period

Verification of Fantasy Bingo Card

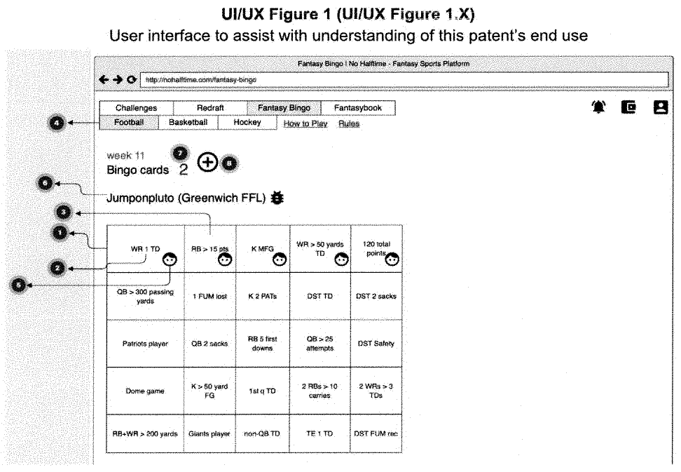

The verification of Fantasy Bingo Card means to determine which of the achievements (UI/UX FIG. 1.2) have been reached or unlocked by the user's players (Backend System FIG. 2.16). The verification of achievements starts with the receiving of sports data from a 3rd party data feed provider. The XML or JSON data parsed based on the sporting event(s). The receiving of new sports data triggers a process to check the achievements stored in the Bingo Card Storage (database) (Backend System f.17). As achievements from Bingo Cards are verified, the results are communicated to the appropriate user on their gameplay device in real-time via a real-time notification system.

Bingo Card Storage

The Bingo Card Storage is a part of the system used for storing Bingo Cards created by users and the associated players/team. The Bingo Card storage groups achievements from the same event together making it easier for the system to verify as new data event data is received. The Bingo Card storage also tracks the results of each Bingo Card for future reference or audit purposes. The Bingo card storage may be contained in databases which reside on cloud hosting servers or local computing machines.

Frontend Visualization of Gameplay

The Frontend Visualization of Gameplay is the encompassing UI/UX the end user interacts with in order to play the Fantasy Bingo (UI/UX FIGS. 1.1-1.8). The Frontend Visualization includes the following: 1) Fantasy Bingo game type 2) Player/team selection 3) Bingo card monitoring for progress 4) final gameplay results

Fantasy Bingo Game Type

The user may be able to select whether they want to participate in a single game Fantasy Bingo game or multi-game Fantasy Bingo game. A single game Fantasy Bingo card means that each player's statistic from their single game performance can be counted toward the bingo card. A multi-game Fantasy Bingo game means player's statistic are accumulated from multiple game performances.

The default Fantasy Bingo Game type can be a winning bingo card if N consecutive achievements are unlocked as shown in UI/UX f.1. In one embodiment, N is greater than or equal to 1. The N consecutive achievements can be unlocked in a horizontal (row(s)), vertical (column(s)), or diagonally. The user can also win Fantasy Bingo by getting selected/highlighted achievements unlocked, for example the four corner achievements if unlocked could be considered a winning Bingo Card. The user can also be able to win if they unlock all achievements on the Bingo Card, also known as a “Blackout”. The user may be able to generate as many Fantasy Bingo Cards at this step as they desire. Payment for generated Bingo Card may be done at submission of the said generated Bingo Card(s).

Player/Team Selection—Team Construction

Once the Bingo card has been generated by the Bingo Card Generator, the application links a team of players to the card for the Fantasy Bingo Card Verification system to determine if the selected team of players unlocked the achievements on the Bingo Card. The user has two options for designating a team, 1) The user can link an imported team, or 2) draft a new team using a salary cap to be associated with the Bingo card. For option 1) the application can link a fantasy sports team created on another fantasy sports platform, for example in a NFL fantasy bingo card the user's team must consist of at minimum 1 QB, 2 RB, 2 WR, 1 TE, 1 Flex (RB or WR or TE). The aforementioned formation of players is the minimum standard across all the top fantasy sports platforms (e.g., ESPN, Yahoo and CBS Sports). Once the team is linked players must be designated to participate in the Fantasy Bingo Card generated. The process is then repeated for each card generated. For option 2) the user can use a Daily Fantasy Sports style, salary cap draft or no salary cap draft to select the players that can participate in the Fantasy Bingo Card. For salary cap based drafts, the user is given a budget and must select players with assigned values to build team(s). The app may allow only the required players to be drafted, for example; 1 QB, 2 RB, 2 WR, 1 TE, 1 Flex (RB or WR or TE). Once a team is linked to the Bingo card, the system can automatically monitor if the nominated players unlock any of the achievements on the generated Bingo card. Nominated players can unlock multiple achievements on the Bingo card. Once the team is linked the user can submit the card with payment.

Bingo Card Monitoring

The Fantasy Bingo card once submitted to the Backend System may sit in the Bingo card storage awaiting verification. As achievements are unlocked on the user's Bingo cards, the notification can be sent to the users' devices where they are viewing the Fantasy Bingo card. The notifications may be sent in real-time to achieve maximum engagement for users in the platform. As achievements are unlocked, the Fantasy Bingo card can be updated visually to display the achievement unlocked and the nominated player UI/UX f.5. The user can also be notified when the Fantasy Bingo card wins a prize based on the type of Bingo card generated.

Final Gameplay Results

The final gameplay results can be displayed to the user in their device and they may be able to view the history of Fantasy Bingo cards previously played. The user can be able to select the nominated Bingo card if they desire further information on the achievements unlocked. The user will be able to view the final results and any associated winnings with the Fantasy Bingo card.

Determining Probabilities Independent of Player

The bingo gameplay features a novel concept for the embodiment of fantasy sports as the probability of winning is independent of the players selected. The probabilities of achievements are calculated based on a large pool of player statistics, and the achievements can either be positive or negative in nature. Positive achievements are events that are considered good or helpful to a winning outcome for a player or team. Negative achievements are events that are considered bad or hurtful to a winning outcome for a player or team. For example, a player scoring points would be considered positive toward their respective team winning the game, whereas alternatively a player throwing an interception would be considered negative. The achievements on the bingo card will be both positive and negative, and independent of the players selected. This concept levels or makes even the chances of winning between beginners and experts of fantasy sports.

1. A method for generating a fantasy bingo card, comprising:
determining for a particular event type (event type=sporting event/football/basketball, etc), a first set of achievements (achievements=potential entries on bingo card);
receiving a first data set, wherein the first data set includes recorded statistics associated with the particular event type;
parsing the first data set to generate a parsed first data set;
inputting into, a data science system, the parsed first data set to generate one or more achievement probabilities associated with one or more of the first set of achievements;
grouping into different categories, based on an associated achievement probability, the one or more first set of achievements (grouping according to the probability certain achievements into certain categories); and
generating, based at least on the different categories, a N×N matrix comprising one or more of the first set of achievements.

2. A method for generating a fantasy bingo card of claim 1, further comprising:
causing, a first user device, to display the N×N matrix within a graphical user interface.

3. A method for generating a fantasy bingo card of claim 1, wherein the different categories includes: a first category for achievements that have an associated achievement probability between 99%-80% (easy);
a second category for achievements that have an associated achievement probability between 79%-60%;
a third category for achievements that have an associated achievement probability between 59%-40%;
a fourth category for achievements that have an associated achievement probability between 39%-20%;
a fifth category for achievements that have associated achievement probability between 19%-1% (hard);

4. The method for generating a fantasy bingo card of claim 1, wherein the generating of the one or more achievement probabilities further comprises:
determining, the one or more achievement probabilities, independently from the participants associated with the recorded statistics.

5. A system for updating statistical data, the system comprising of a non-transitory computer-readable medium and a processor, wherein when the non-transitory computer-readable medium is executed by the processor, causes the processor to:
store, in one or more databases, statistical data;
in response to receiving a new dataset, perform, based at least in part on a portion of the statistical data and a portion of the new dataset, Machine Learning (ML) related calculations;
update, based on the ML related calculations, one or more ML models;
modify, based on the one or more ML models, one or more calculations of achievement probabilities; and
in response to receiving a request from a device, generating, based on the one the more calculations of achievement probabilities, one or more achievements for inclusion in a fantasy bingo card.

6. A server system, comprising:
one or more processors;
a first storage system;
a computer network communication system;
a real-time notification system for pushing alerts to end client devices and receiving requests from end client devices, wherein the one or processors performs:
Receiving, via the computer network system, a first request for status or results;
Storing, in the first storage system, information associated with the first request:
In response to storing the information associated with the first request a response is pushed, via the real-time notification system, as an alert to an end client device of the end client devices.
